(19) United States
(12) Patent Application Publication
(10) Pub. No.: US 2002/0084329 A1
(43) Pub. Date: Jul. 4, 2002

(54) Coded items for labeling objects

(76) Inventors: Paul H. Kaye, Kimpton (GB); Mark C. Tracey, Hertford Heath (GB); John A. Gordon, Datchworth Green (GB)

Correspondence Address: Kit M. Stetina, STETINA BRUNDA GARRED & BRUCKER, Suite 250, 75 Enterprise, Aliso Viejo, CA, 92656, US

(21) Appl. No.: 10/010,613

(22) Filed: Dec. 5, 2001

Related U.S. Application Data
(63) Continuation-in-part of application No. 09/565,426, filed on May 5, 2000, now abandoned.
Application No. 09/565,426 is a continuation of application No. 08/737,532, filed on Jul. 16, 1997, now abandoned.
Application No. 08/737,532 is a 371 of international application No. PCT/US95/00756, filed on Jan. 20, 1995.
Application No. 08/737,532 is a 371 of international application No. 09/634,514, filed on Aug. 8, 2000.
Application No. 09/634,514 is a continuation of application No. 09/066,296, filed on Apr. 27, 1998, now abandoned.
Application No. 09/066,296 is a 371 of international application No. PCT/GB96/02617, filed on Oct. 25, 1996.

(51) Int. Cl. G06K 7/10

(52) U.S. Cl. 235/462.01

(57) ABSTRACT

A microparticle which is invisible to the naked eye and is marked with digitally coded machine readable information, the machine readable information being etched through the microparticle.

### CROSS-REFERENCE TO RELATED APPLICATIONS

The present invention is a continuation-in-part application of U.S. Ser. No. 09/565,426 filed May 5, 2000 entitled CODED MICROPARTICLE IDENTIFICATION LABELS FOR PLACEMENT ON OBJECTS, which is a continuation application of U.S. Ser. No. 08/737,532 filed Oct. 25, 1996, which is the United States National Phase Under 35 U.S.C. §371 of International Application PCT/US95/00756 filed Mar. 15, 1995, and is a continuation-in-part application of U.S. Ser. No. 09/634,514 entitled CODED PARTICLES FOR PROCESS SEQUENCE TRACKING IN COMBINATORIAL COMPOUND LIBRARY PREPARATION which is a continuation application of U.S. Ser. No. 09/066,296 filed Apr. 27, 1998 which is the United States National Phase filing under 35 U.S.C. §371 of International Application PCT/GB96/02617 filed Oct. 25, 1996.

### STATEMENT RE: FEDERALLY SPONSORED RESEARCH/DEVELOPMENT

(Not Applicable)

### BACKGROUND OF THE INVENTION

This invention relates to coded items for labeling objects such as vehicles, credit cards and jewelry, and is particularly useful for the invisible labeling of such objects with security marks to enable the objects to be identified or their origin to be identified.

Many methods are employed to protect merchantable items from theft or forgery. Car chassis and engines have serial numbers, credit cards have holographic icons, etc. Ultimately, all these devices can be defeated by either removal or replication. Ideally, an time would be marked with a security device which was impossible to remove or replicate, or where the effort required to remove or replicate it exceeded the value of the item itself.

There have been several methods devised for the production of particles which carry some form of information in such a way as to allow the particles to potentially be used as a method of marking or identifying an object. These constitute the prior art to the invention. Dillon, for example (U.S. Pat. No. 4,243,734) describes microdots carrying indicia identifying the owner of an article. The microdots are small pieces of foil which carry the printed indicia and which are mechanically cut from a larger sheet of foil. Because of the nature of the cutting process, the microdots are restricted to one of several polygonal shapes, the preference being square of side typically from 0.003 inches (76 micrometers) to 0.125 inches (3100 micrometers). LaPerre (U.S. Pat. No. 4,329,393) describes particles carrying information by way of visually distinguishable colored layers. The particles are produced by the random commination of brittle laminates, and have therefore irregular and uncontrolled shape, with typical sizes along the broadest dimension of between 15 and 1000 micrometers across the colored layers. Stevens (U.S. Pat. No. 4,390,452) describes similar particles which carry information by way of one or a number of identifying features such as colored layers, fluorescent or phosphorescent material layers, or the presence of trace elements. Again, the particles are produced by the shattering of brittle laminates into irregular broken pieces, with typical sizes along the broadest dimension of between 15 and 1000 micrometers. In all of these methods, the shape of individual particles is either uncontrolled or is restricted to one of several simple polygonal geometries. The information carried on these microparticles is either alpha-numeric or color coded.

### BRIEF SUMMARY OF THE INVENTION

In a first aspect, the invention provides a microparticle which is invisible to the naked eye and is marked with digitally coded machine readable information, the machine readable information being etched through the microparticle.

The invention also provides a microparticle having a hole or notch etched therethrough representative of a unique code selected from a multiplicity of such codes.

The invention also provides a tagging compound comprising a powder, fluid or gas when mixed with one or more set or sets of microparticles or which each has a predetermined shape representative of a unique code selected from a multiplicity of such codes, such that the presence of the microparticles is undetectable to the naked eye.

The invention also provides a method of marking an object invisibly with a machine readable code, comprising applying to the object a set of microparticles of the above type.

By applying such microparticles to an item, the item can be marked extensively or even covered without detracting from its aesthetic or practical purpose.

Preferably, the microparticle is in the form of a wafer whose thickness is from 0.1 μ to 5 μ and whose width and length are both in the range of 0.5 μ to 50 μ; preferably, the microparticle is of silicon or silicon dioxide. Such particle can be made by micromachining.

Silicon micromachining is a process developed from the electronics industry. The processes and techniques used in silicon micromachining are based largely upon the highly refined fabrication technology used in semiconductor manufacture—with the objective in micromachining being the creation of microscopic physical or mechanical structures on silicon wafer substrates as opposed to electronic circuitry.

It has been shown in The Production of Precision Silicon Micromachined Non-Spherical Particles for Aerosol Studies—Kay P. H., Micheli F., Tracey M., Hirst E., and Gundlach A. M., Journal of Aerosol Science Vo. 23, Supplement 1, pp 201-204, 1992 that extremely uniform microscopic particles of silicon or silicon dioxide (glass) or a metal such as aluminum, silver, or gold, can be made using the process of silicon micromachining.

Micromachined particles may be of dimensions from about 0.5 μ to 50 μm or more across, and from about 0.1 to 5 μm thick. (A printed period mark by comparison is typically 500 μm across.) The shapes of the particles are designed using a computer-aided-design (CAD) program and may be of virtually any designed form within the limitations mentioned above. A single silicon wafer of normally 7.5 cm (3 inch) or 20 cm (8 inch) diameter is used as the substrate on to which the desired particle shapes are projected using an optical mask or directly drawn using so-called e-beam writing. The particles are subsequently formed on the wafer using the deposition and etching processes of silicon micromachining. Typically 200 million particles can be formed on a 7.5 cm (3 inch) wafer, each of the particles accurately defined in size and shape. Normally all the particles on one wafer are designed to be of identical size and shape so that when the particles are freed from the wafer substrate (using a further etching process) one is left with a suspension containing a single particle type.

Each particle is marked with etched-through holes or notches suitably in the same etching process that forms the microparticles so that the particles or group of particles is characterized by a unique mark. These holes are not pits or grooves but extend through the particle. The holes suitably form a binary code or some other encrypted coding which only the designer of the particle may have access to. Each particle could then carry a code of typically several hundred binary “bits” of information. It is particularly preferred that the particles carry some form of micromachined orientation marking, for example one or more notches at a standard location in order to readily identify the orientation of the microparticle to assist the code reading process.

### BRIEF DESCRIPTION OF THE DRAWINGS

FIG. 1 discloses a microparticle having a hole or notched etched therethrough.

### DETAILED DESCRIPTION OF THE INVENTION

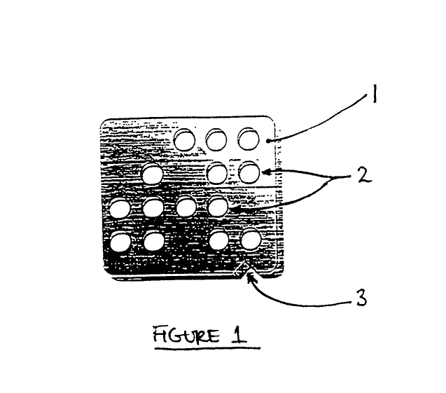

Referring to FIG. 1, the preferred embodiment of microparticle is a silicon wafer 1 that is formed by micromachining and the forming process, or subsequently, is through-etched with a plurality of suitably substantially circular holes 2 which collectively form an identifying pattern. A notch 3 to serve as orientation marker is provided near one corner of the wafer 1.

In order unambiguously to optically image a unique binary number etched forming pattern on the microparticle, it is necessary for each constituent mark which represents a binary bit of the number to satisfy Abbe's Condition for the microscopic imaging system in question.

The microparticles of the present invention achieve this in an optimal manner by virtue of the markings being holes or notches as aforementioned. They can thus be back-lit and read by detecting light passing through them, giving far more efficient resolution than relying on direct reflected light. Furthermore, even when detecting the marks by monitoring reflected light, the marks can be far more readily differentiated than markings that are mere surface pits or grooves.

With while light illumination and a microscope objective of Numerical Aperture 0.5, the bit spacing should typically exceed approximately 1.2 micrometers. Such an objective, in reflector form, can display a working distance of approximately 16 mm and a usable depth of field of approximately 5 micrometers. Such a microscope would be suitable for the analysis of objects such as credit cards or identity cards. Microscopic analysis of larger objects would either require a sample to be removed for analysis (for instance a paint sample from an automobile) or would require the design of a microscope mounting specific to that application (for instance, a magnetic mounting or precisely defined objective to base distance such that when held on a plane it is in focus).

An alternative to microscopic analysis would be offered by the employment of a scanning system (analogous to a very high resolution “bar code reader”) employing a laser beam and appropriate optics to produce a narrow, collimated beam in conjunction with electronics to control the beam and interpret the interaction between the beam and the object under scrutiny. Such a system could offer a focused working distance range sufficient to allow handheld scrutinization instruments to be employed.

Additionally, the particles should be patterned in such a manner as to ensure that ambiguous pattern interpretation cannot occur in the case of 90, 180 or 270 degree rotation from the intended viewing orientation; ambiguous interpretation due to imaging the microparticles incorrect face should also be precluded. The addition of unique corner patterns could be employed to achieve this.

A particle meeting this design constraint, when imaged by a microscope, will form an image on the imaging element of a video camera. This image, in electronic form, can be digitized and processed by a computer using image processing software. Numerous conventional algorithms can be employed by this software to uniquely identify the morphology of the imaged microparticle. Their operation would typically involve:

(i) Delineating the object image from its background. This operation would be performed by a general purpose commercial image processing package such as Optimas or Visilog.

(ii) Interpreting the morphology of the object in order to ascertain the pattern of marks and hence the unique binary number. This operation would probably employ custom-written software to interpret the data produced by (i) above.

A suspension of particles, all having identical code markings, may then be used to uniquely identify an object and thus act as a security tag. Examination of the particles on the object can be achieved, for example with an optical reader similar to (though of higher resolution than) a bar code reader found in supermarkets, and the code contained on the particles then identifies the rightful ownership of the object.

For example, an item of jewelry such as a gold necklace could be coated, in part or whole, with a transparent lacquer containing a suspension of particles. The lacquer would dry to become invisible, and the particles contained, though invisible to the human eye, could nevertheless be viewed using a suitable magnifying device so as to reveal the hidden identity code. To avoid the possibility of the lacquer being removed by a solvent (thus removing the particles as well), the particles could be stamped into the jewelry at the time of hallmarking, thus becoming essentially part of the item itself, resilient to removal without totally removing the hallmarks (which would normally significantly reduce the value of the item).

Another example could be the unique marking of credit cards and similar “plastic” devices for electronic financial transactions, or paper currency or security bonds, etc. The cards could be marked at some point(s) with an “ink” containing the particles. Again, the particles would each carry a copy of a unique coding tag which could be traceable to the rightful owner of the card. An imaging system, again like a bar code reader, could be used to “read” the data on the particles and ascertain the authority of ownership. Removal of the ink and particles would render the card invalid.

Another example would be to apply the particles (all having the same code) with the top layer of paint or varnish onto a motor car. The particles, invisible to the naked eye, would not detract from the appearance of the vehicle. By coating the whole vehicle, inner facing panels included, with this coded paint, a potential thief would have to remove all the paint from the vehicle to remove all the particles in order to prevent its true identification becoming known. Such a process, and subsequent repainting, would involve so much labor as to render the original theft non-profitable. Typically, one particle per square millimeter of surface area would be required to coat the vehicle. This may amount to 20 million particles per vehicle, i.e. corresponding to approximately one-tenth of a 7.5 cm (3 inch) wafer's worth.

A further example would be to incorporate the particles in so-called security smoke devices. These devices are found, for example, in hole-in-the-wall cash machines and armored vehicles. They release, automatically, a smoke dye to cover the currency and possibly the thief when disturbed. The particles would also cover the currency and thief and, because they would carry a unique code, would provide a means of linking a specific item of currency or person to the specific incident.

Any item could, in theory, be marked in this way to provide identifying security marks. The particles have many advantages including that (i) they can be made identically and in huge numbers by the process of micromachining—they can be made, if desired, in silicon dioxide, i.e. glass (colored, if required) and as such be impervious to most acids, etc.; (ii) their product, i.e. through the process of micromachining, is non-trivial and requires highly specialized equipment and skills, thus unauthorized replication of the particles would be very difficult to achieve; and (iii) they are essentially invisible to the naked eye.

If more information is required to identify an article, a mixture of two or more sets of differently coded particles could be applied, at the cost of longer read time by the optical scanning device.

Although, in many examples, it is appropriate to coat outer surfaces of the objects with the identifying particles, it is envisaged that liquids and other fluid materials such as drinks, fuels and perfumes could be marked by mixing with the microparticles. Even solid objects could be impregnated internally with the microparticles, or the microparticles could be mixed with fluid materials during the manufacture of the solid objects, i.e. in a mould.

1. A microparticle which is invisible to the naked eye characterized in that it is marked with digitally coded machine readable information, the machine readable information being etched through the microparticle as at least one hole or notch.

2. A microparticle as claimed in claim 1, wherein the microparticle is in the form of a wafer whose thickness is from 0.1 μm to 5 μm and whose width and length are both in the range of 0.5 μm to 50 μm.

3. A microparticle according to claim 1, wherein the machine readable information is in the form of a binary code.

4. A microparticle according to claim 1 or claim 2, wherein the microparticle incorporates an orientation marker.

5. A microparticle according to any preceding claim comprising silicon, silicon dioxide or a metal.

6. A microparticle according to claim 4, comprising silicon or silicon dioxide.

7. A microparticle according to any preceding claim whose machine readable code is readable by an optical device.

8. A microparticle according to any preceding claim, in which the code is representative data comprising a multiplicity of bits.

9. A set of a multitude of substantially identically encoded microparticles each according to any preceding claim.

10. A set of microparticles according to claim 9, all being of substantially the same size and shape.

11. A tagging compound comprising a powder, fluid or gas mixed with one or more sets of microparticles, wherein each set is a multitude of substantially identically encoded microparticles each marked with digitally coded machine readable information, the machine readable information being etched through the microparticle as at least one hole or notch, such that the presence of the microparticle is undetectable to the naked eye.

12. A tagging compound comprising one or more set or sets of microparticles according to claim 9 mixed with a powder, fluid or gas, such that the presence of the microparticles in the mixture is undetectable to the naked eye.

13. A tagging compound according to claim 11, comprising a paint or ink or fluid dye.

14. A tagging compound according to claim 11, comprising a smoke dye.

15. A container for tagging an object or objects with a readable code, said container containing a tagging compound comprising a powder, fluid or gas mixed with one or more set or sets of microparticles, wherein each set is a multitude of substantially identically encoded microparticles each marked with digitally coded machine readable information, the machine readable information being etched through the microparticles as at least one hole or notch, and having means for dispensing the tagging compound from the container.

16. A container for tagging an object or objects with a readable code, containing a tagging compound according to claim 11, and having means for dispensing the tagging compound from the container.

17. A method of marking an object invisibly with a machine readable code, characterized by applying to the object a set of a multitude of substantially identically encoded microparticles each marked with digitally coded machine readable information, the machine readable information being etched through the microparticle as at least one hole or notch.

18. A method of marking an object invisibly with a machine readable code, characterized by applying to the object a set of microparticles according to claim 9.

19. A method of marking a vehicle invisibly with a machine readable code, characterized by applying a coat of paint or ink or fluid dye to the vehicle surface a tagging compound comprising a powder, fluid or gas mixed with one or more set or sets of microparticles, wherein each set is a multitude of substantially identically encoded microparticles each marked with digitally coded machine readable information, the machine readable information being etched through the microparticle as at least one hole or notch.

20. A method of marking a vehicle invisibly with a machine readable code, characterized by applying to the vehicle a set of a multitude of substantially identically encoded microparticles, in which the set of microparticles is part of a tagging compound according to claim 13 and is applied as a coating to the vehicle surface.

21. A method of an inherently valuable item such as jewelry invisibly with a machine readable code, characterized by applying to the inherently valuable item such as jewelry a set of a multitude of substantially identically encoded microparticles each invisible to the naked eye and marked with a machine readable code, in which the set of microparticles is part of a tagging compound comprising a powder, fluid or gas mixed with one or more set or sets of microparticles, wherein each set is a multitude of substantially identically encoded microparticles each marked with digitally coded machine readable information, the machine readable information being etched through the microparticle as at least one hole or notch and is supplied as a transparent hardenable lacquer to the surface of the item.

22. A method of marking an inherently valuable item such as jewelry invisibly with a machine readable code, characterized by applying to the inherently valuable item such as jewelry a set of a multitude of substantially identically encoded microparticles each invisible to the naked eye and marked with digitally coded machine readable information, in which the set of microparticles is part of a tagging compound according to claim 13 and is applied as a transparent hardenable lacquer to the surface of the item.

23. A method of marking an inherently valuable item such as a plastic card, credit card or charge card invisibly with machine readable information, characterized by applying to the inherently valuable item such as a plastic card, credit card or charge card, a set of a multitude of substantially identically encoded microparticles each invisible to the naked eye and marked with digitally coded machine readable information, in which the set of microparticles is part of a tagging compound according to claim 13 and is applied selectively as an ink or lacquer.

24. A security device for cash machines or other public access dispensing devices, fitted with a container according to claim 16 in the form of an automatically actuable smoke canister filled with the tagging compound which comprises a smoke dye mixed with one or more set or sets of microparticles, wherein each set is a multitude of substantially identically encoded microparticles each marked with digitally coded machine readable information, the machine readable information being etched through the microparticle as at least one hole or notch.

25. A security device for cash machines or other public access dispensing devices, fitted with a container according to claim 16 in the form of an automatically actuable smoke canister filled with the tagging compound which comprises a smoke dye.

26. A microparticle having at least one hole or notch etch therethrough representative of a unique code selected from a multiplicity of such codes.

27. A microparticle which has been etched to have a predetermined shape representative of a unique code selected from a multiplicity of such codes.
